(19) United States
(12) Patent Application Publication
(10) Pub. No.: US 2026/0196116 A1
(43) Pub. Date: Jul. 9, 2026

(54) MONITORING METHOD AND MONITORING SYSTEM

(71) Applicant: Glory Ltd., Himeji-shi (JP)

(72) Inventor: Aya KANO, Himeji-shi (JP)

(73) Assignee: Glory Ltd., Himeji-shi (JP)

(21) Appl. No.: 19/430,338

(22) Filed: Dec. 23, 2025

(30) Foreign Application Priority Data
Jan. 7, 2025 (JP) 2025-002247

(51) Int. Cl. G08B 13/196; G06Q 20/02; G06V 20/40; G06V 20/52; G06V 40/16

(52) U.S. Cl. CPC G08B 13/196; G06Q 20/02; G06V 20/44; G06V 20/52; G06V 40/161

(57) ABSTRACT

A monitoring method performed by a monitoring system includes: registering, in a database, monitoring information on a person captured by a first camera installed for monitoring; detecting, by a detection device, a predetermined action performed by a monitoring person who possesses a second camera; and notifying the monitoring person of information on a person captured by the second camera obtained from the database, through a notification device possessed by the monitoring person, based on a detection result of the predetermined action.

### CROSS-REFERENCE RELATED TO APPLICATION

The present application is a continuation of, and claims priority to, Japanese patent application JP2025-002247, filed Jan. 7, 2025, the entire contents of which is incorporated herein by reference.

### TECHNICAL FIELD

The present disclosure relates to a monitoring method and a monitoring system for monitoring persons in a monitoring area.

### BACKGROUND ART

Conventionally, monitoring activities have been performed in various places. For example, in a store that sells various products to customers, monitoring activities are performed using a monitoring camera to prevent crimes such as theft of products. Japanese Laid-Open Patent Publication No. 2013-196043 discloses a system that tracks movements of customers by using a plurality of monitoring cameras, and detects fraudulent acts by using captured images and sensors. The monitoring activity in the store is performed by a security guard in a monitoring room. The security guard checks videos captured by the monitoring cameras and displayed on a display, in real time. A fraudulent act is automatically detected by the monitoring system and the detection result is displayed on the display to notify the security guard. The burden on monitoring activities can be greatly reduced.

According to the conventional technique, the security guard checking the screen on the display in the monitoring room finds a suspicious activity of a customer and contacts another security guard patrolling the store, whereby the security guard on the sales floor can directly confirm the situation. Meanwhile, if a security guard patrolling the store finds a suspicious person, this security guard has to access an apparatus in the monitoring room by operating a communication terminal to confirm information relevant to the suspicious person, or has to ask another security guard in the monitoring room to confirm the information, which is time-consuming. In recent years, since plastic shopping bags for storing purchased products have been increasingly avoided in view of environmental concerns, it is difficult to confirm whether a product carried by a customer has been paid for, which has affected monitoring activities.

The present disclosure has been made in view of the problem, as well as other problems, of the conventional art, and the present disclosure addresses these issues, as discussed herein, with a monitoring method and a monitoring system facilitating monitoring activities.

A monitoring method according to one aspect of the present disclosure is performed by a monitoring system, and includes: registering, in a database, monitoring information on a person captured by a first camera installed for monitoring; detecting, by a detection device, a predetermined action performed by a monitoring person who possesses a second camera; and notifying the monitoring person of information on a person captured by the second camera obtained from the database, through a notification device possessed by the monitoring person, based on a detection result of the predetermined action.

### BRIEF DESCRIPTION OF THE DRAWINGS

FIG. 1 illustrates an outline of a monitoring system according to the present embodiment;

FIG. 2 shows an example of a configuration of the monitoring system;

FIG. 3 is a flowchart illustrating a process of registering information in a monitoring database;

FIG. 4 shows an example of a monitoring database;

FIG. 5 is a flowchart illustrating a process performed during monitoring activities of a monitoring person;

FIG. 6 illustrates an example of a notification process; and

FIGS. 7A to 7C illustrate other examples of a wearable device and a notification process.

### DESCRIPTION OF THE PREFERRED EMBODIMENTS

Hereinafter, an embodiment of a monitoring method and a monitoring system according to the present disclosure will be described with reference to the accompanying drawings. An area where monitoring is performed using the monitoring system of the present disclosure is not particularly limited. In the present embodiment, a store that sells items to customers will be described as an example. A person who performs monitoring activities in the store is not particularly limited. Examples of the person may include a store clerk who serves customers, a clerk in charge of monitoring, and a security guard belonging to a security company. Hereinafter, a person who performs monitoring activities in the store is referred to as a monitoring person, and a customer as a monitoring subject in the store is referred to as a customer or a person.

### [Outline of Monitoring System]

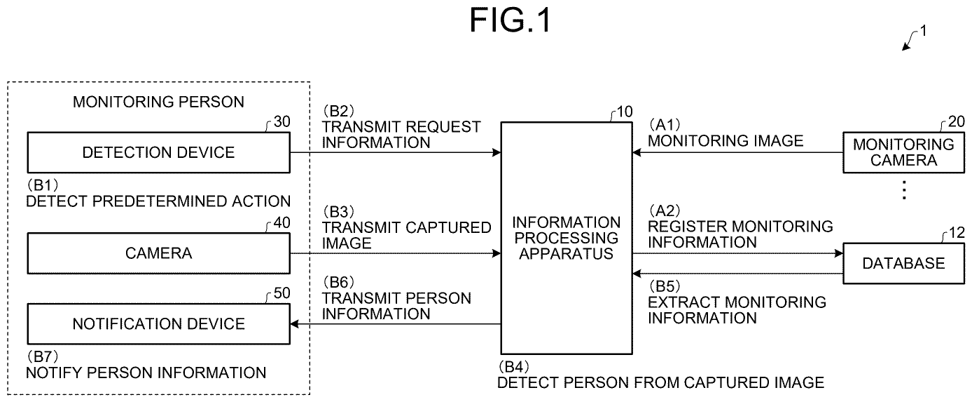

FIG. 1 illustrates an outline of a monitoring system 1 according to the present embodiment. The monitoring system 1 includes: an information processing apparatus 10; a monitoring camera 20; a detection device 30; a camera 40; and a notification device 50. The detection device 30, the camera 40 and the notification device 50 are worn by a monitoring person. The monitoring person possesses the detection device 30, the camera 40, and the notification device 50 to perform monitoring activities. For example, each of a plurality of monitoring persons is equipped with the detection device 30, the camera 40, and the notification device 50, and performs monitoring activities such as patrolling the store and monitoring an area of which he/she is in charge.

The monitoring camera 20 transmits a monitoring image obtained by capturing customers in the store, to the information processing apparatus 10 (A1). The number of monitoring cameras 20 included in the monitoring system 1 is not particularly limited. For example, a plurality of monitoring cameras 20 are installed on a sales area of items, a checkout counter where payment for purchased items is performed, and the like. The monitoring image outputted from the monitoring camera 20 may be a moving image and/or a still image.

The information processing apparatus 10 registers and manages, in a database 12, monitoring information of each person obtained from the image captured by each monitoring camera 20 (A2). A computer device including a control circuitry, a memory, and a communication unit may be used as the information processing apparatus 10. The installation place of the information processing apparatus 10 is not particularly limited. The information processing apparatus 10 may be implemented by a virtual server. The database 12 may be stored in the memory included in the information processing apparatus 10, or may be stored in an external device communicably connected to the information processing apparatus 10.

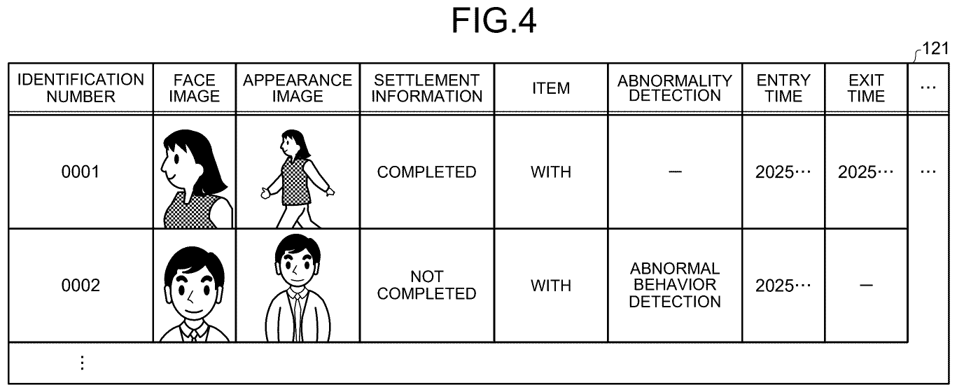

For example, the information processing apparatus 10 analyzes the monitoring image acquired from the monitoring camera 20 to detect persons included in the image, and gives an identification number to each person. The information processing apparatus 10 registers images of an appearance and a face in the database 12 for monitoring, together with the identification number (see FIG. 4). The information processing apparatus 10 recognizes that a customer puts an item in a shopping cart or basket, or holds an item in his/her hand, based on the monitoring image of the sales area, and registers information indicating each behavior in the database 12 in association with the identification number of the customer. The information processing apparatus 10 recognizes that a customer has paid for an item based on the monitoring image of the checkout counter, and registers information indicating this payment in the database 12 in association with the identification number of the customer. Recognition of the faces, appearances, behaviors, etc., based on the monitoring image may be performed using conventionally known techniques.

The information processing apparatus 10 may recognize that a customer has an item, by using a sensor such as an optical sensor or a weight sensor that detects an item having been taken out from an item shelf, instead of or in addition to the monitoring image. The information processing apparatus 10 may recognize that a customer has completed payment for an item, based on information acquired from a settlement apparatus used to perform a settlement process for purchased items, instead of or in addition to the monitoring image.

Information on the face or appearance of each person in the store, information on whether the person has an item to purchase, information on whether the person has completed payment for the item he/she has, etc., are included in the database 12 managed by the information processing apparatus 10. The information processing apparatus 10 updates the information in the database 12, based on the images captured by each monitoring camera 20.

The monitoring person performs monitoring activities while carrying the detection device 30, the camera 40, and the notification device 50. The detection device 30, the camera 40, and the notification device 50 may be independently provided, or any two or all three of them may be integrated into one device.

The detection device 30 detects a predetermined action performed by the monitoring person (B1). For example, the detection device 30 detects, as a predetermined action, motion of a part of the body of the monitoring person, such as a finger, hand, or foot, from the images captured by the camera 40 and/or a camera included in the detection device 30. For example, the detection device 30 may detect, as a predetermined action, a predetermined gesture of the monitoring person, such as opening a closed hand or waving a hand.

The detection device 30 may include a microphone. From audio acquired by the microphone, the detection device 30 may detect, as a predetermined action, sound made by the monitoring person with his/her fingers or hands, voice uttered by the monitoring person, or the content of the utterance. The detection device 30 may detect sound as a predetermined action by using a microphone included in the camera 40 and/or the notification device 50, instead of or in addition to the microphone in the detection device 30. For example, the sound made by the monitoring person with his/her fingers or hands, and/or predetermined words uttered by the monitoring person may be detected, as a predetermined action, by the detection device 30 using at least one microphone.

The detection device 30 may include a manipulator such as a button or a touch panel. The detection device 30 may detect, as a predetermined action, an operation performed on the manipulator by the monitoring person, such as pressing the button or tapping or zooming in/out on the touch panel. The detection device 30 may detect a predetermined action performed on a manipulator included in the camera 40 and/or the notification device 50. For example, the detection device 30 may detect, as a predetermined action, an operation of pressing a button included in the camera 40 or the notification device 50, or a zoom operation of enlarging or reducing an image captured by the camera 40 and displayed on a display included in the camera 40 or the notification device 50.

The detection device 30 may include a sensor that detects vibration, such as an acceleration sensor or a piezoelectric sensor. The detection device 30 may detect, with the sensor, an action of the monitoring person tapping the device a predetermined number of times, as a predetermined action. The detection device 30 may detect an action of the monitoring person shaking the device, as a predetermined action. For example, the action of tapping or shaking the detection device 30 may be detected by the sensor based on vibration generated in the detection device 30. Instead of or in addition to the sensor in the detection device 30, a sensor included in the camera 40 and/or the notification device 50 may be used to detect vibration as a predetermined action.

When the detection device 30 has detected a predetermined action of the monitoring person, the detection device 30 or the device including the detection device 30 transmits request information for requesting information on the customer, to the information processing apparatus 10 (B2). The request information may include the date and time when the detection device 30 detected the predetermined action.

The image captured by the camera 40 possessed by the monitoring person is transmitted from the camera 40 or the device including the camera 40 to the information processing apparatus 10 (B3). The image captured by the camera 40 may be transmitted when the detection device 30 has detected a predetermined action, or may be constantly transmitted to the information processing apparatus 10. The captured image to be transmitted may be a moving image and/or a still image.

Upon receiving the request information from the detection device 30, the information processing apparatus 10 detects a person included in the captured image received from the camera 40 (B4). In a case where the image captured by the camera 40 is transmitted because the detection device 30 has detected a predetermined action, the information processing apparatus 10 may detect a person from this captured image. In a case where the captured image is constantly transmitted from the camera 40, the information processing apparatus 10 may detect a person from the captured image, based on the date and time included in the request information, when the detection device 30 detected the predetermined action. Detection of a person from an image may be performed using a conventionally known image recognition technique.

Upon detecting persons from the image captured by the camera 40, the information processing apparatus 10 extracts information on each person detected from the captured image, with reference to information registered in the database 12 (B5). The information processing apparatus 10 transmits the information on each person acquired from the database 12 to the notification device 50 or the device including the notification device 50 (B6). The notification device 50 notifies the monitoring person of the information on each person received from the information processing apparatus 10 (B7).

For example, the information transmitted from the information processing apparatus 10 to the notification device 50 includes an image of the face and/or appearance of each person, information indicating whether the person has an item, and information indicating whether the person has completed payment for the item that he/she has.

The notification device 50 including a display for displaying the information received from the information processing apparatus 10 to notify the monitoring person of the information. For example, the notification device 50 displays lists including the images of the respective persons received from the information processing apparatus 10 and information on the respective persons acquired from the database 12.

The notification device 50 may display a still image captured by the camera 40 when the detection device 30 has detected a predetermined action, and may overlay the information acquired from the database 12 on the still image such that the information on each person corresponds to the image of each person. Each piece of information is displayed such that the relation between the information and the corresponding person among the persons captured in the still image becomes clear. The notification device 50 may display the image currently being captured by the camera 40 in real time on the display while overlaying the information for each person included in the image.

The notification device 50 may include an audio reproduction unit, and at least a part of the information may be reproduced as voice from the audio reproduction unit to notify the information. For example, a voice reading out the information may be output from an earphone worn by the monitoring person. The monitoring person can hear an important part or all of the information from the earphone. The audio reproduction unit may be a speaker to output information by voice.

The monitoring person can confirm the information on each person captured by the camera 40, based on the content of the notification performed by the notification device 50. For example, if a customer is about to leave the store with an unpaid item, the monitoring person can recognize this fact and handle the situation, based on the notified information.

As described above, using the monitoring system 1 makes it unnecessary for the monitoring person to refer to the database 12 by operating the conventional communication terminal to search for information on a customer from a large quantity of registered data. For example, if the monitoring person wants to confirm whether a customer has completed payment for an item, the monitoring person only needs to cause the detection device 30 to detect a predetermined action while the customer is in the imaging area that can be captured by the camera 40. The imaging area may be referred to as the field of view of the camera 40. With detection of the predetermined action as a trigger, a process of detecting a customer from the image captured by the camera 40, extracting information on this customer from the database 12 for monitoring, and notifying the monitoring person of the information, is automatically performed in the monitoring system 1. The monitoring person can easily confirm the information on each person captured by the camera 40 by using the detection device 30 and the notification device 50.

### [Example of Configuration of Monitoring System]

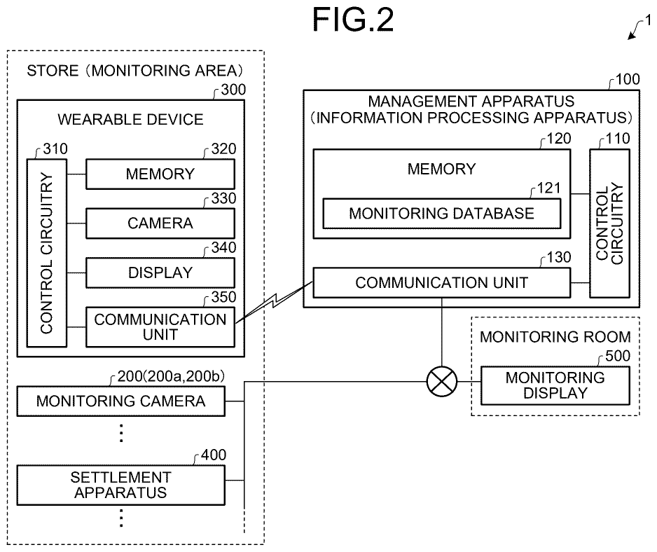

FIG. 2 shows an example of a specific configuration of the monitoring system 1. The monitoring system 1 shown in FIG. 2 includes a management apparatus 100, a monitoring camera 200, a wearable device 300, a settlement apparatus 400, and a monitoring display 500.

The management apparatus 100 is an example of the information processing apparatus 10 shown in FIG. 1. The management apparatus 100 includes a control circuitry 110, a memory 120, and a communication unit 130. The memory 120 is a non-volatile storage device. The memory 120 stores therein various kinds of information necessary for the operation of the management apparatus 100. The information stored in the memory 120 includes a monitoring database 121.

The communication unit 130 is used for transmitting/receiving information to/from external devices. Such external devices include the monitoring camera 200, the wearable device 300, the settlement apparatus 400, and the monitoring display 500. The management apparatus 100 may communicate with the monitoring camera 200, the settlement apparatus 400, and the monitoring display 500 wirelessly or via wires. The management apparatus 100 communicates with the wearable device 300 wirelessly.

The control circuitry 110 controls each of the components of the management apparatus 100. For example, a program corresponding to the control circuitry 110 is stored in the memory 120 or a dedicated storage device in advance, and the program is executed by hardware such as a CPU to implement the functions and operations of the control circuitry 110. The control circuitry 110 controls each component based on the information transmitted/received via the communication unit 130 and the information stored in the memory 120, whereby the functions and operations of the management apparatus 100 described in the present embodiment are implemented. In the present embodiment, the functions and operations of the management apparatus 100 implemented by the control circuitry 110 may be described simply as the functions and operations of the management apparatus 100.

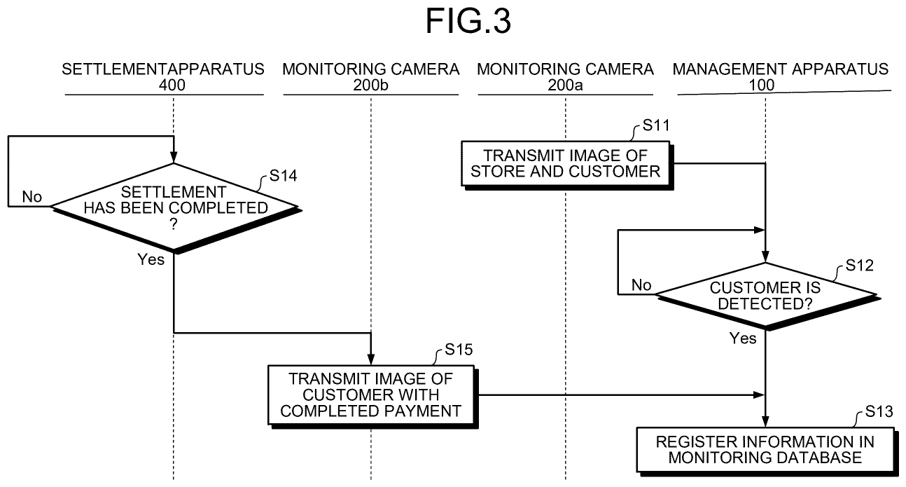

The monitoring camera 200 is installed in a store, i.e., a monitoring area that is a target of monitoring activities performed by using the monitoring system 1. The number of monitoring cameras 200 is not particularly limited. Depending on the scale and/or the sales floor layout of the store, a plurality of monitoring cameras 200 may be appropriately installed to capture images of customers in the store. The monitoring cameras 200 may include: a monitoring camera 200a for monitoring whether a customer has an item at the entrance of the store and/or the sales area of items sold in the store; and a monitoring camera 200b for monitoring whether the customer has completed payment for the item at the checkout counter (see FIG. 3).

The settlement apparatus 400 is installed at the checkout counter of the store, and performs a settlement process for items that the customer purchases. The settlement apparatus 400 may be a cash register such as a POS register, or a device called a self-checkout register or a semi-self-checkout register. The settlement apparatus 400 may include a monitoring camera 200b that captures an image of the customer who performs payment for the item.

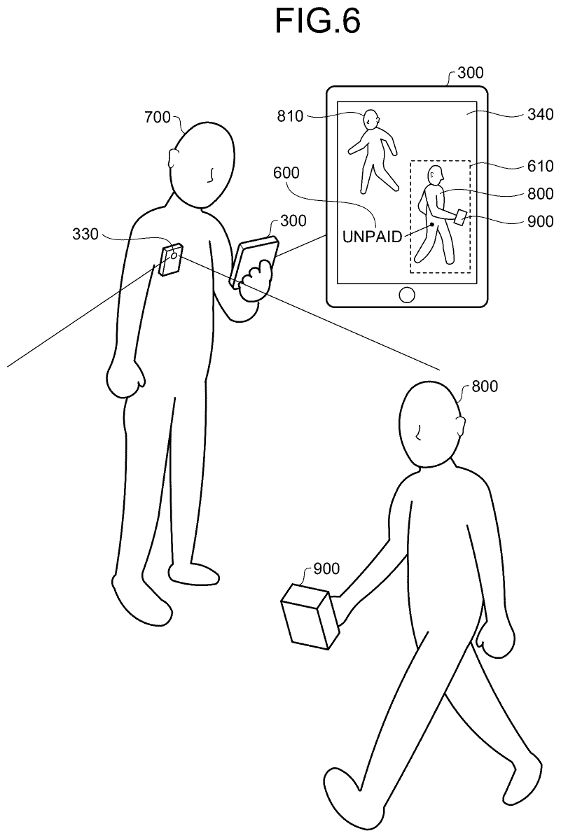

The wearable device 300 includes a control circuitry 310, a memory 320, a camera 330, a display 340, and a communication unit 350. The wearable device 300 is an example of a device including the detection device 30, the camera 40, and the notification device 50 shown in FIG. 1. In the example shown in FIG. 2, the camera 330 functions as both the detection device 30 and the camera 40 shown in FIG. 1. The display 340 functions as the notification device 50 shown in FIG. 1. The monitoring person who wears the wearable device 300 performs monitoring activities while moving inside and outside the store (see FIG. 6).

The memory 320 is a non-volatile storage device that stores therein information necessary for the operation of the wearable device 300. The communication unit 350 is used for transmitting/receiving various kinds of information to/from external devices. The external devices include the management apparatus 100.

The control circuitry 310 controls each of the components of the wearable device 300. For example, a program corresponding to the control circuitry 310 is stored in the memory 320 or a dedicated storage device in advance, and the program is executed by hardware such as a CPU to implement the functions and operations of the control circuitry 310. The control circuitry 310 controls each component based on the information transmitted/received via the communication unit 350 and the information stored in the memory 320, whereby the functions and operations of the wearable device 300 described in the present embodiment are implemented. In the present embodiment, the functions and operations of the wearable device 300 implemented by the control circuitry 310 may be described simply as the functions and operations of the wearable device 300.

FIG. 2 shows an example of the wearable device 300, and does not limit the configuration of the wearable device 300. For example, the camera 330 and the display 340 may be disposed in the housing of the wearable device 300. At least one of the camera 330 and the display 340 may be separated from the housing of the wearable device 300, and may be connected to the control circuitry 310 directly or via the communication unit 350. The wearable device 300 may include an audio output device such as a speaker, earphones, etc., that functions as the notification device 50, instead of or in addition to the display 340. The wearable device 300 may include an audio input device such as a microphone that functions as the detection device 30, instead of or in addition to the camera 330.

The monitoring display 500 is a display device installed in the monitoring room. For example, a display of a computer device including a control circuitry, a memory, the display, and a communication unit is used as the monitoring display 500. The management apparatus 100 may include a display, and the display of the management apparatus 100 installed in the monitoring room may be used as the monitoring display 500. The monitoring images captured by the monitoring cameras 200 installed in various places in the store are displayed on the monitoring display 500 in real time.

When the monitoring person, who performs monitoring activities with the monitoring display 500 in the monitoring room, performs an operation for selecting a suspicious person on the image displayed on the monitoring display 500, the image of the suspicious person is transmitted to the management apparatus 100. Based on the image of the suspicious person selected on the monitoring display 500, the management apparatus 100 specifies information on the corresponding person from the information registered in the monitoring database 121. For example, information on the suspicious person is specified based on the correlation between the face and/or appearance of the suspicious person selected on the monitoring display 500 and the image of the face and/or appearance of each person registered in the monitoring database 121. The information specified by the management apparatus 100 is displayed on the monitoring display 500. Also, The information specified by the management apparatus 100 is displayed on the display 340 of the wearable device 300.

For example, if the person selected as a suspicious person on the monitoring display 500 appears in an image currently being captured by the camera 330 of the wearable device 300, information indicating that this person has been selected, as the suspicious person, in the monitoring room is displayed on the display 340 of the wearable device 300. Specifically, the image currently being captured by the camera 330 is displayed on the display 340, and on this image, the suspicious person is surrounded by a frame or is provided with a speech bubble indicating “suspicious person”, so that the suspicious person is distinguishable from other persons, for example. Thus, the monitoring person patrolling the store can confirm, with the wearable device 300, the information on the suspicious person who is selected by the other monitoring person using the monitoring display 500 in the monitoring room.

Likewise, when the monitoring person patrolling the store has performed an operation for selecting a suspicious person on the image displayed on the display 340 of the wearable device 300, information on this suspicious person may be shared with another monitoring person via the management apparatus 100. When a person selected as a suspicious person by the first monitoring person appears in the image currently being captured by the camera 330 of the wearable device 300 of the second monitoring person, information indicating that this person has been selected as the suspicious person is displayed on the display 340 of the wearable device 300 of the second monitoring person. For example, the image currently being captured by the camera 330 is displayed, and on this image, the suspicious person may be surrounded by a frame or may be provided with a speech bubble indicating “suspicious person”. Thus, the information on the suspicious person can be shared between a plurality of monitoring persons patrolling the store. The information on the suspicious person may also be shared with the monitoring person using the monitoring display 500 in the monitoring room in the same manner.

The monitoring system 1 may include another display device on which an image captured by the monitoring camera 200 is processed and displayed. For example, the management apparatus 100 processes the image captured by the monitoring camera 200 such that the face of each person included in the image is not recognizable, and displays the processed image on the display device. For example, an image to be displayed on the display is processed such that the face and/or the whole body of each person are blurred. For another example, the image is processed such that each person is displayed to resemble a thermographic image, from which the face and the body cannot be recognized in the processed image. In a case where a large display device is installed at the entrance of the store, the item sales area, the checkout counter, etc., to display the monitoring image while protecting the privacy of customers by processing the captured image, it becomes obvious that the inside of the store is being monitored, and an effect of preventing crimes such as shoplifting can be expected.

### [Registration of Information in Monitoring Database]

FIG. 3 is an example of flowchart illustrating a process of registering information in the monitoring database 121. The monitoring cameras 200a installed at various sites in the store, such as the entrance and the item sales area, transmit captured monitoring images to the management apparatus 100 (step S11).

The management apparatus 100 determines whether any customer is included in the monitoring image received from each monitoring camera 200a (step S12). If there is no customer in the monitoring image (step S12; No), the management apparatus 100 does not perform a process regarding the monitoring image. On the other hand, if a customer is included in the monitoring image (step S12; Yes), the management apparatus 100 registers information on this customer in the monitoring database 121 (step S13).

For example, the management apparatus 100 recognizes a customer who visits the store from the image captured by the monitoring camera 200a at the entrance of the store, assigns an identification number to this customer, and registers the identification number in the monitoring database 121 together with the image of this customer. The management apparatus 100 recognizes a customer who puts an item in a shopping basket or cart, or a customer who starts to move with an item in his/her hand, from the image captured by the monitoring camera 200a in the item sales area, and registers information indicating that this customer has the item, in association with the identification number of this customer registered in the monitoring database 121.

The customer pays for the item by using the settlement apparatus 400 installed at the checkout counter to purchase the same. At the checkout counter, the monitoring camera 200b that monitors the customer who pays for the item captures an image of the customer.

In the settlement apparatus 400 in the standby state (step S14; No), when the settlement process is completed (step S14; Yes), a captured image is transmitted from the monitoring camera 200b used for capturing an image of the customer who uses the settlement apparatus 400, to the management apparatus 100 (step S15). The management apparatus 100 recognizes, from the image captured by the monitoring camera 200b, the customer who has completed the settlement process with the settlement apparatus 400, and registers information indicating that the customer has completed payment for the item in association with the identification number of this customer registered in the monitoring database 121 (step S13).

For example, the monitoring camera 200b that has detected completion of the settlement process, based on the operation performed with the settlement apparatus 400, may transmit the captured monitoring image of the customer to the management apparatus 100, and the management apparatus 100 may recognize the customer who has completed payment for the item from the received monitoring image and register the information in the monitoring database 121. In the case where the monitoring camera 200b constantly transmits the monitoring image to the management apparatus 100, the settlement apparatus 400 may notify the management apparatus 100 that the settlement process is completed, and the notified management apparatus 100 may recognize the customer who has completed the payment from the monitoring image captured by the monitoring camera 200b and register the information in the monitoring database 121. If the settlement apparatus 400 includes the monitoring camera 200b, the settlement apparatus 400 may transmit the monitoring image obtained by capturing the customer who has completed the payment, to the management apparatus 100 when the settlement process is completed, and the management apparatus 100 may register the information in the monitoring database 121.

### [Monitoring Database]

FIG. 4 shows an example of the monitoring database 121. As shown in FIG. 4, in the monitoring database 121, each person in the store is given an identification number to be distinguished from other persons. For each person, information such as the face image, appearance image, settlement information, and item are registered in the monitoring database 121. The monitoring database 121 may include information such as abnormality detection, entry time, and exit time. The monitoring database 121 may include other items. For example, the monitoring database 121 may include information such as the customer's stay time in each area or the number of times the customer is detected by the same monitoring camera 200, which makes it obvious that the customer has been in the same place for a long time.

The face image shown in FIG. 4 is an image obtained by cutting out an area corresponding to the face of each person from the image captured by the monitoring camera 200. The appearance image is an image obtained by cutting out an area corresponding to the upper body or the whole body of each person from the image captured by the monitoring camera 200. The management apparatus 100, which has registered the face image and the appearance image in the monitoring database 121, compares the face and the appearance of a person who appears in a new monitoring image with the images registered in the monitoring database 121 to identify the identification number of each person, and registers information on the person in the monitoring database 121 in association with the identified identification number. Even when face recognition is difficult due to wearing sunglasses or a hat, or even when a part of the face is covered by the figure or body of another customer and is not captured, the management apparatus 100 can identify the person by using the appearance image.

Although FIG. 4 shows one face image and one appearance image for each person, the management apparatus 100 detects and records images of each person obtained from the monitoring images of all the monitoring cameras 200.

The management apparatus 100 may store all the monitoring images of the monitoring cameras 200, in the memory 120 until a predetermined period (e.g., one year) elapses. The management apparatus 100 may have, in the memory 120, information to specify a monitoring image in which the face image and the appearance image of each person were detected, from among the stored monitoring images. For example, when the identification number of a customer registered in the monitoring database 121 is entered by operating the monitoring display 500, the management apparatus 100 displays a list of face images and appearance images detected for this person and stored in the memory 120, on the screen of the monitoring display 500. When the monitoring person operates the monitoring display 500 and selects a face image or an appearance image from the listed images, the monitoring image (moving image) captured by the monitoring camera 200 in which the selected image was detected is reproduced on the screen of the monitoring display 500. This allows the monitoring person to retroactively confirm the behavior of each person. Upon receiving an operation for specifying a person from the image currently being monitored in real time, the management apparatus 100 may extract and list the face images and the appearance images of the specified person, or may extract and list the face images and the appearance images having characteristics similar to those of the specified person, such that the images and information on the specified person can be displayed on the monitoring display 500.

The settlement information shown in FIG. 4 indicates whether the customer has completed payment for the item with the settlement apparatus 400 at the checkout counter. In the example shown in FIG. 4, the customer with identification number “0001” has completed the settlement process, but the customer with identification number “0002” has not completed the settlement process.

Information registered under the “item” shown in FIG. 4 indicates whether each person has an item. The information is initially registered as “without”, and it is updated to “with” when the management apparatus 100 has recognized that the customer has picked up an item, put an item in a shopping cart or basket or is carrying an item, from the image captured by the monitoring camera 200. Information such as the type, name, and quantity of the item carried by the customer may be registered under the “item”. For example, the management apparatus 100 may recognize the information on the item based on the image captured by the monitoring camera 200, the detection result of the sensor installed on the item shelf, and the like, and register the information under the “item”.

Information registered under the “abnormality detection” indicates a suspicious action and/or a suspicious behavior of the customer detected by the management apparatus 100 from the monitoring image captured by the monitoring camera 200. For example, if the management apparatus 100 monitoring the behavior of each person based on the monitoring image detects that the customer picks up an item and puts it in his/her clothes or bag, the management apparatus 100 registers information indicating this fact in the monitoring database 121. For another example, if the management apparatus 100 detects a customer who is in the same place for a long time or a customer who is loitering in the store for a long time period, based on a preset threshold time, the management apparatus 100 registers information indicating this fact in the monitoring database 121. Detection of such suspicious actions or behavior may be performed by using a human action recognition process that is conventionally known. The example shown in FIG. 4 indicates that the management apparatus 100 has detected an abnormal behavior of a customer with identification number “0002”.

The management apparatus 100 may register, in the monitoring database 121, information such as the time during which the customer stays at the same place (stay time for each area) or the number of times the customer is detected by the same monitoring camera 200. For example, the management apparatus 100 may acquire the stay time for each area by counting up the time during which the same person is continuously captured by the same monitoring camera 200 or the time during which the same person is captured by at least one of a plurality of monitoring cameras 200 grouped for each area. Likewise, the management apparatus 100 may acquire the number of detections of the same person for each area by counting up the number of times the same person is detected by a single monitoring camera 200 or a plurality of monitoring cameras 200 grouped for the same area. The stay time and the number of detections may not necessarily be registered under the “abnormality detection”, and may be registered in the monitoring database 121 separately from “abnormality detection”. The management apparatus 100 notifies the monitoring person of the information such as the stay time or the number of detections for each area, as information on the customer. The monitoring person who checked the notification content can talk to the customer or take necessary measures.

Under the “entry time” and “exit time” shown in FIG. 4, the entry time and the exit time, which are specified by the management apparatus 100 detecting each person with the monitoring cameras 200 installed at the entrance and the exit of the store, are registered. The management apparatus 100 may detect entry and exit of each person by using mechanical sensors or optical sensors installed at the entrance and the exit.

Additional detection information regarding the customer may be registered in the monitoring database 121. For example, weight sensors may be installed on the floor surface at the entrance and the exit of the store, and the weights of visiting customers may be registered in the monitoring database 121. By preparing Information on the weights of items sold in the store in advance, the management apparatus 100 can calculate the weight of items for which the customer has completed payment by using the settlement apparatus 400. The management apparatus 100 detects the weight of the customer leaving the store by the weight sensor at the exit, and compares the detected weight with a weight obtained by adding the weight of the paid items to the weight at the time of entry registered in the monitoring database 121. If the weight at the time of leaving the store has increased compared to the weight at the time of entry and a value obtained by subtracting the weight of the paid items from the increased amount exceeds a predetermined threshold, the management apparatus 100 determines that the customer leaving the store may have an unpaid item. The management apparatus 100 transmits information on this customer to the monitoring display 500 or the wearable device 300 to notify the monitoring person of the information. For example, the face image and/or the appearance image of this customer, and information to instruct to check this customer are displayed on the display 340 of the wearable device 300. As a result, the monitoring person patrolling the store, who has received the notification, can talk to and check with the customer, or the monitoring person in the monitoring room can confirm the behavior of the customer after visiting the store based on the stored monitoring image (moving image) and take necessary measures.

In the present embodiment, as shown in FIG. 4, the management apparatus 100 registers various kinds of information in the monitoring database 121, but this is an example and does not limit the information handling method of the management apparatus 100. For example, the management apparatus 100 may store each piece of information individually without using the database such that the management apparatus 100 can recognize the correspondence between each piece of information and information related thereto.

### [Monitoring Activity]

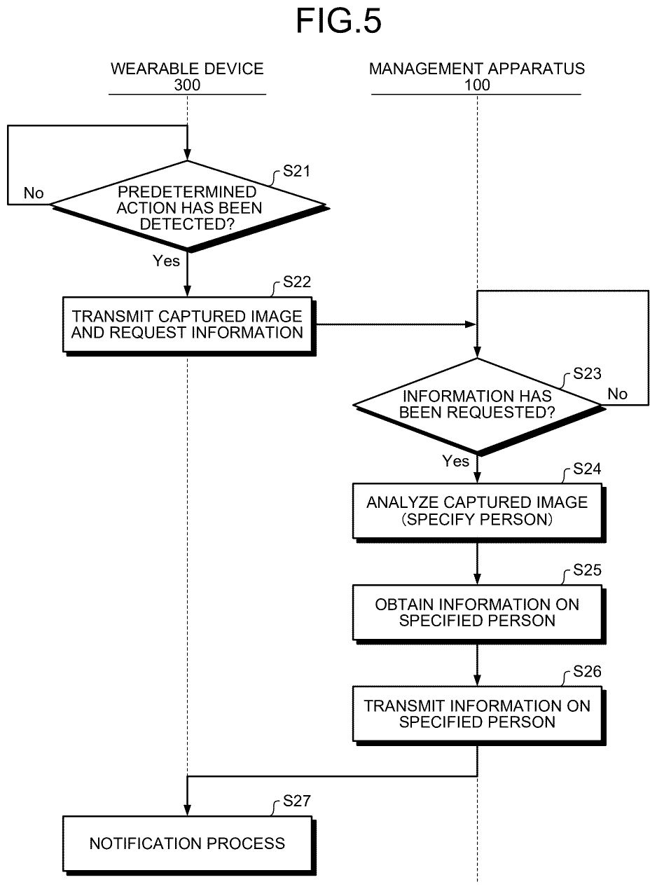

FIG. 5 is a flowchart illustrating an example of a process performed by a monitoring person wearing the wearable device 300 during his/her monitoring activities. When the wearable device 300 in the standby state (step S21; No) detects, by the camera 330, that the monitoring person has performed a predetermined action (step S21; Yes), the wearable device 300 transmits the image captured by the camera 330 and request information for requesting information on persons included in the captured image, to the management apparatus 100 (step S22).

For example, when the monitoring person wearing the wearable device 300 performs a predetermined action of covering the camera 330 attached to his/her upper body with his/her hand, the wearable device 300 detects this action. Based on the image captured by the camera 330, the wearable device 300 waits for the monitoring person to lower the hand that performed the predetermined action, and transmits the image captured by the camera 330 to the management apparatus 100 together with the request information. The wearable device 300 may transmit, to the management apparatus 100, an image captured by the camera 330 before the monitoring person performs a predetermined action. Setting may be made such that it is possible to select whether to transmit an image before detection of a predetermined action or an image after the detection.

The management apparatus 100 in the standby state (step S23; No) receives the request information (step S23; Yes), and analyzes the image captured by the camera 330 to specify persons included in this image (step S24). The management apparatus 100 extracts information on each person in the image captured by the camera 330 with reference to the monitoring database 121 shown in FIG. 4 (step S25). The management apparatus 100 transmits the information extracted from the monitoring database 121 to the wearable device 300 (step S26). Upon receiving the information from the management apparatus 100, the wearable device 300 performs a notification process (step S27).

For example, the wearable device 300 displays the information on the display 340 to notify the monitoring person of the information obtained from the management apparatus 100. The display 340 may display the still image transmitted to the management apparatus 100 in step S22, and information on each person included in the still image. The display 340 displays the information such that the monitoring person can confirm whether each person in the image has an item and whether the person has completed payment for the item.

For example, on the screen of the display 340, persons who have completed payment for items are displayed to be distinguishable from other persons. For example, on the screen of the display 340, a person who has an item but has not yet completed payment for the item is displayed to be distinguishable from other persons.

In addition to the information regarding possession and payment for items, other information registered in the monitoring database 121 may be displayed on the screen. For example, if a detected suspicious action of putting an item in a customer's bag has been registered under the “abnormality detection” in the monitoring database 121, this information may be displayed on the screen of the display 340. For example, information such as the stay time for each area indicating the time during which each person has stayed in the same place, or the number of times each person has been detected by the same monitoring camera 200 or a plurality of monitoring cameras 200 in the same area, may be displayed on the screen of the display 340.

The monitoring person can confirm other information registered in the monitoring database 121 by operating the wearable device 300. When the notification process is performed, and the monitoring person performs an operation for selecting a person displayed on the display 340, pieces of information registered under “item”, “abnormality detection”, “entry time”, etc., in the monitoring database 121 for this person are displayed on the screen of the display 340. For example, the monitoring person can confirm all pieces of information registered in the monitoring database 121. Information such as the type, name, quantity, etc., of the item that the customer has, suspicious action or behavior, stay time in the same area, number of detections in the same area, entry time, elapsed time from the entry time, etc., may be displayed on the screen of the display 340. The monitoring person can use these pieces of information for the monitoring activities.

### [Notification Process]

FIG. 6 illustrates an example of a notification process. In the example shown in FIG. 6, the wearable device 300 includes a portable communication terminal including the control circuitry 310, the memory 320, the display 340 and the communication unit 350, and the camera 330 that is separated from the portable communication terminal. The wearable device 300 acquires an image captured by the camera 330 through wireless communication via the communication unit 350. A monitoring person 700 uses the camera 330 attached to his/her chest or arm.

For example, as shown in FIG. 6, when the monitoring person 700 desires to confirm whether a customer 800 having an item 900 has completed payment for the item 900, the monitoring person 700 performs a predetermined action so that a part of the monitoring person 700 can be captured by the camera 330. As a result, the predetermined action is detected by the camera 330, and information on the customer 800, which has been searched for from the monitoring database 121 by the management apparatus 100, is displayed on the display 340 of the wearable device 300, as described with reference to FIG. 5.

As shown in FIG. 6, an image captured by the camera 330 is displayed on the screen of the display 340. The information obtained from the monitoring database 121 is overlaid on the captured image. On the screen of the display 340, the person 800 who has not completed payment for the item 900 and a person 810 who has completed payment are displayed in a distinguishable manner. For example, as shown in FIG. 6, the person 800 having the unpaid item 900 is surrounded by a frame 610. For example, information 600 such as characters or a symbol indicating that the person 800 has the unpaid item 900 is displayed in association with the corresponding person 800. This allows the monitoring person 700 to easily confirm whether the customer 800 has completed payment for the item 900.

### [Modifications]

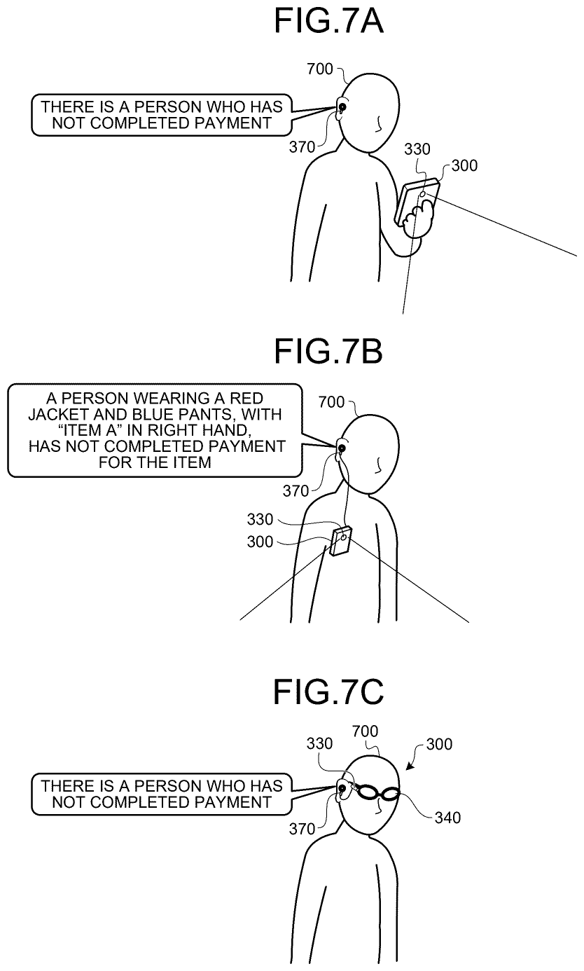

FIGS. 7A to 7C illustrate other examples of the wearable device 300 and the notification process. In FIG. 6, the wearable device 300 is composed of the main body including the display 340 and the camera 330 separate from the main body. However, as shown in FIG. 7A, the wearable device 300 may include the camera 330.

As shown in FIG. 7A, the wearable device 300 may include an audio reproduction unit 370 such as a wireless earphone used for the notification process. In this case, the monitoring person 700 is notified that there is a person who has not completed payment for an item by voice reproduced from the audio reproduction unit 370 in addition to the information displayed on display 340, whereby the information can be notified more reliably.

Instead of the notification by information display shown in FIG. 6, and the notification by both information display and audio reproduction shown in FIG. 7A, notification by audio only may be performed as shown in FIG. 7B. In this case, in step S26 in FIG. 5, the management apparatus 100 may recognize the feature of a person having an unpaid item, based on the image captured by the camera 330 and/or the image of the appearance registered in the monitoring database 121, and transmit the same to the wearable device 300. The wearable device 300 may cause the audio reproduction unit 370 to reproduce the features received from the management apparatus 100. For example, the type, name, and quantity of the item for which the person has not completed payment and/or information regarding the appearance of this person may be reproduced by audio to allow the monitoring person 700 to easily identify the person. Examples of the information regarding the appearance include the height, body shape, color of hair, length of hair, color of eyes, and color of skin, of the person. The examples may further include feature of glasses, hat, mask, earrings, etc., that the person wears, and the outfit of the person.

As shown in FIG. 7C, a glasses-type wearable device 300 may be used. This wearable device 300 may include a camera 330, a display 340, and an audio reproduction unit 370. If the above information is displayed on the display 340 provided in a lens portion of the glasses, the monitoring person 700 can check the displayed information without holding a device including the display 340 in his/her hand, and can use both hands for other actions.

A monitoring method according to the present embodiment is a method performed by a monitoring system, and includes: registering, in a database, monitoring information on a person captured by a first camera installed for monitoring; detecting, by a detection device, a predetermined action performed by a monitoring person who possesses a second camera; and notifying the monitoring person of information on a person captured by the second camera obtained from the database, through a notification device possessed by the monitoring person, based on a detection result of the predetermined action.

In the above configuration, the second camera may be used as the detection device, and the predetermined action may be detected based on an action of the monitoring person captured by the second camera.

In the above configuration, a manipulator included in the second camera and/or the notification device may be used as the detection device, and the predetermined action may be detected based on an operation performed on the manipulator by the monitoring person.

In the above configuration, the detection device may include a microphone, and the predetermined action may be detected based on sound acquired by the microphone.

In the above configuration, the detection device may include a sensor to detect a vibration, and the predetermined action may be detected based on a vibration detected by the sensor.

In the above configuration, the monitoring information may include: an image of at least one of a face and an appearance of a customer captured by the first camera installed in a store; and at least one of information indicating whether the customer has an item sold in the store and information indicating whether the customer has completed payment for the item.

In the above configuration, the information indicating whether the customer has completed payment for the item may be acquired from a settlement apparatus that the customer uses for the payment for the item.

In the above configuration, the notification device may perform notification such that it is possible to confirm whether the person captured by the second camera has an item, and/or whether the person has completed payment for the item. The image captured by the second camera may be displayed in real time, and additional information may be displayed on the real time image.

In the above configuration, the notification device may include a display, and an image captured by the second camera may be displayed on the display such that a person who has completed payment for the item is displayed so as to be distinguishable from other persons. The image captured by the second camera may be displayed in real time, and additional information may be displayed on the real time image.

In the above configuration, the notification device may include a display, and an image captured by the second camera may be displayed on the display such that a person who has an item but has not completed payment for the item is displayed so as to be distinguishable from other persons. The image captured by the second camera may be displayed in real time, and additional information may be displayed on the real time image.

In the above configuration, the monitoring method may further include: receiving an operation of the monitoring person for selecting a person displayed on the display; and displaying, on the display, information registered in the database for the selected person.

In the above configuration, the notification device may include an audio reproduction unit, and information regarding the feature of the person who has not completed payment for the item and is included in an image captured by the second camera, may be reproduced as voice by the audio reproduction unit.

In the above configuration, the monitoring method may further include: displaying an image captured by the second camera possessed by a first monitoring person, on a display unit possessed by the first monitoring person; receiving an operation of the first monitoring person for selecting, as a monitoring targe, a person displayed on the display; and notifying, when the person having been selected as the monitoring target is captured by the second camera possessed by a second monitoring person, the second monitoring person of this fact by using the notification device. The information on the monitoring target, which may be obtained from the database, may be notified to the first monitoring person and the second monitoring person. The image captured by the second camera may be displayed in real time, and additional information may be displayed on the real time image.

In the above configuration, the monitoring method may further include: displaying an image captured by the first camera on a display used in the monitoring room; receiving an operation for selecting, as a monitoring target, a person displayed on the monitor in the monitoring room; and notifying, when the person having been selected as the monitoring target is captured by the second camera possessed by the monitoring person, the monitoring person of this fact by using the notification device. In the store, the monitoring target selected in the monitoring room may be notified to the monitoring person on the sales floor. The information on the monitoring target, which may be obtained from the database, may be notified to the first monitoring person and the second monitoring person. The image captured by the second camera may be displayed in real time, and additional information may be displayed on the real time image.

A monitoring system according to the present embodiment includes: a first camera installed for monitoring; a second camera possessed by a monitoring person; a detection device configured to detect a predetermined action performed by the monitoring person; a notification device possessed by the monitoring person; and an information processing apparatus configured to register, in a database, monitoring information on a person captured by the first camera, extract information on a person captured by the second camera from the database in a case where the detection device has detected the predetermined action, and notify the monitoring person of the information through the notification device.

According to the monitoring system of the present disclosure, it is possible to monitor a person more easily than in the conventional system.

The configuration of the monitoring system 1 disclosed in the present embodiment is conceptually fundamental, and the configuration of the monitoring system 1 may not necessarily be physically limited thereto. Distributed or integrated forms of each device are not limited to the above-described forms, and all or some of the forms may be distributed or integrated functionally or physically in any unit depending on various loads, use statuses, or the like.

The embodiment of the monitoring system according to the present disclosure has been described with reference to the drawings. However, the configurations and operations of the monitoring system and the devices constituting the monitoring system are not limited to the above embodiment, and may be carried out with various improvements, alterations, and modifications, based on the knowledge of those skilled in the art without departing from the spirit thereof.

What is claimed is:

1. A monitoring method performed by a monitoring system, comprising:
registering, in a database, monitoring information on a person captured by a first camera installed for monitoring;
detecting, by a detection device, a predetermined action performed by a monitoring person who possesses a second camera; and
notifying the monitoring person of information on a person captured by the second camera obtained from the database, through a notification device possessed by the monitoring person, based on a detection result of the predetermined action.

2. The monitoring method according to claim 1, wherein
the second camera is used as the detection device and the predetermined action is detected based on an action of the monitoring person captured by the second camera.

3. The monitoring method according to claim 1, wherein
a manipulator included in the second camera or the notification device is used as the detection device and the predetermined action is detected based on an operation performed on the manipulator by the monitoring person.

4. The monitoring method according to claim 1, wherein
the detection device includes a microphone and the predetermined action is detected based on sound acquired by the microphone.

5. The monitoring method according to claim 1, wherein
the detection device includes a sensor to detect a vibration and the predetermined action is detected based on a vibration detected by the sensor.

6. The monitoring method according to claim 1, wherein
the monitoring information includes:
an image of at least one of a face and an appearance of a customer captured by the first camera installed in a store; and
at least one of information on whether the customer has an item sold in the store, and information on whether the customer has completed payment for the item.

7. The monitoring method according to claim 6, wherein
the information on completion of payment is acquired from a settlement apparatus that the customer uses for the payment for the item.

8. The monitoring method according to claim 6, wherein
the notification device performs the notification such that it is possible to confirm whether the person captured by the second camera has an item and whether the person has completed payment for the item.

9. The monitoring method according to claim 6, wherein
the notification device includes a display and an image captured by the second camera is displayed on the display such that a person who has completed payment for an item is distinguishable from other persons.

10. The monitoring method according to claim 6, wherein
the notification device includes a display and an image captured by the second camera is displayed on the display such that a person who has an item but has not completed payment for the item is distinguishable from other persons.

11. The monitoring method according to claim 9, further comprising:
receiving an operation of the monitoring person for selecting a person displayed on the display; and
displaying, on the display, information registered in the database for the selected person.

12. The monitoring method according to claim 6, wherein
the notification device includes an audio reproduction unit and information on feature of a person, who has not completed payment for an item and is included in an image captured by the second camera, is reproduced as voice by the audio reproduction unit.

13. The monitoring method according to claim 1, further comprising:
displaying an image captured by the second camera possessed by a first monitoring person, on a display possessed by the first monitoring person;
receiving an operation of the first monitoring person for selecting, as a monitoring target, a person displayed on the display; and
notifying, in a case where the person having been selected as the monitoring target is captured by the second camera possessed by a second monitoring person, the second monitoring person of information on the monitoring target through the notification device possessed by the second monitoring person.

14. The monitoring method according to claim 1, further comprising:
displaying an image captured by the first camera on a display;
receiving an operation for selecting, as a monitoring target, a person displayed on the display; and
notifying, in a case where the person having been selected as the monitoring target is captured by the second camera possessed by the monitoring person, the monitoring person of information on the monitoring target through the notification device.

15. A monitoring system comprising:
a first camera installed for monitoring;
a second camera possessed by a monitoring person;
a detection device configured to detect a predetermined action performed by the monitoring person;
a notification device possessed by the monitoring person; and
an information processing apparatus configured to register, in a database, monitoring information on a person captured by the first camera, extract information on a person captured by the second camera from the database in a case where the detection device has detected the predetermined action, and notify the monitoring person of the information through the notification device.
